(19) United States
(12) Patent Application Publication
(10) Pub. No.: US 2005/0204156 A1
(43) Pub. Date: Sep. 15, 2005

(54) Method for computer booting via using a motherboard combined with fingerprint recognition module and apparatus for the same

(75) Inventor: Yen Sheng Chang, Tai Chung Hsien (TW)

Correspondence Address: TROXELL LAW OFFICE PLLC, SUITE 1404, 5205 LEESBURG PIKE, FALLS CHURCH, VA, 22041, US

(73) Assignee: GIGA-BYTE TECHNOLOGY CO., LTD.

(21) Appl. No.: 10/796,193

(22) Filed: Mar. 10, 2004

(51) Int. Cl. G06K 9/00

(52) U.S. Cl. 713/200

(57) ABSTRACT

A method for computer booting via using a motherboard combined with a fingerprint recognition module and an apparatus thereof combine a fingerprint recognition module with the computer motherboard and perform a fingerprint input process stored in a basic input/output system (BIOS) during booting or resetting the computer. The method inputs a fingerprint image signal via a fingerprint input module and sends the fingerprint image signal to a fingerprint recognition module to produce a recognition code. Then, it compares the recognition code with at least a pre-stored recognition code to produce a comparison result. Finally, it uses the comparison result to determine if booting the computer is permitted. Thereby, the method and apparatus can employ the fingerprints for identification to provide true computer security and protect a user's privacy.

### FIELD OF THE INVENTION

The present invention is directed to a method for computer booting via using a motherboard combined with a fingerprint recognition module and an apparatus thereof, and more particularly, to a method and apparatus that combines the motherboard with the fingerprint recognition module, which is used to scan the fingerprint, for the security of the computer during booting.

### BACKGROUND OF THE INVENTION

Since each of human fingerprints is unique and can't be lost, the mechanism employing the fingerprints for identification is extensively used in many security systems or occasions. With the progress of science and technology, the hardware apparatus for fingerprint input has been made as a module or a single chip. Hence, it is gradually applied to many computer products or business transaction products, such as, for example, card-reading machines or automatic transfer machines.

As to the application of the computer products, the fingerprint module has been combined with the computer keyboard, computer mouse or computer access device, such as the hard disk or portable disk. Its objective is to secure the computer software or hardware to prevent the computer from access by other persons. However, all of the recent fingerprint apparatuses are connected with the computer externally and need additional software or drivers during connection or actuation. This is quite inconvenient.

In the prior art, computers all have a basic input/output system (BIOS), which has setting values of the computer hardware and a computer booting process used for booting the computer. In general, in order to prevent the computer from unauthorized access, a user usually sets a password in the BIOS. However, other people may steal the password and the programs for removing the password of the BIOS exist as well. Hence, the password can't provide real security. Meanwhile, it is inconvenient for the user if he forgets the password of the BIOS. Therefore, only employing fingerprint for identification can provide real security.

Consequently, in view of the gradual maturation of the fingerprint module and greater attention paid to personal security and privacy, the inventor of this application has studied this topic and proposes a method and apparatus for computer booting via using a motherboard combined with a fingerprint recognition module. The inventor combines the fingerprint recognition module with the computer motherboard and uses the BIOS to drive the fingerprint recognition module directly to provide the security of the computer. Accordingly, the present invention can improve the drawbacks mentioned above.

### SUMMARY OF THE INVENTION

An objective of the present invention is to provide a method and apparatus for computer booting via using a motherboard combined with a fingerprint recognition module. The present invention combines a fingerprint recognition module with the computer motherboard and disposes a fingerprint input module on the computer housing or peripherals to acquire a user's fingerprints for identification during computer booting. Hence, it can be used to secure hardware or software of computers.

For reaching the objective above, the present invention provides a method for computer booting, which disposes a fingerprint recognition module connected with a fingerprint input module on a motherboard of a computer and executes a fingerprint input process stored in a basic input/output system (BIOS) during booting or resetting the computer. First, it inputs a fingerprint image signal via the fingerprint input module and sends the fingerprint image signal to the fingerprint recognition module to produce a recognition code. Then, it compares the recognition code with at least a pre-stored recognition code to produce a comparison result, which is used to determine if booting the computer is permitted.

Preferably, the present invention further provides a method for computer booting, which disposes a fingerprint recognition module connected with a fingerprint input module on a motherboard of a computer and executes a fingerprint pre-storing process stored in a basic input/output system (BIOS) during booting or resetting the computer. First, it inputs a username, employs the fingerprint input module to provide a fingerprint image signal and sends the fingerprint image signal to the fingerprint recognition module to produce a recognition code. Then, it stores the recognition code as a pre-stored recognition code corresponding to the usemame and resets the computer in the end.

Preferably, the present invention further provides a computer motherboard including a BIOS having a booting process, a fingerprint input module used to input at least a first fingerprint image and a fingerprint recognition module electrically connected with the fingerprint input module and the BIOS for abstracting a feature value of the first fingerprint image and encoding the feature value to form a recognition code. When booting the computer, the booting process is able to control the fingerprint recognition module to compare the recognition code with at least a pre-stored recognition code to produce a comparison result used to determine if computer booting is permitted to continue.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional motherboard;

FIG. 2 is a block diagram of a motherboard having a fingerprint recognition module in accordance with the present invention;

FIG. 3 is a schematic diagram of the first embodiment in accordance with the present invention;

FIG. 4 is a schematic diagram of the second embodiment in accordance with the present invention;

FIG. 5 is a block diagram of a fingerprint module in accordance with the present invention;

FIG. 6 is a flowchart of a fingerprint pre-storing process in accordance with the present invention; and

FIG. 7 is a flowchart of a fingerprint input process in accordance with the present invention.

### DETAILED DESCRIPTION

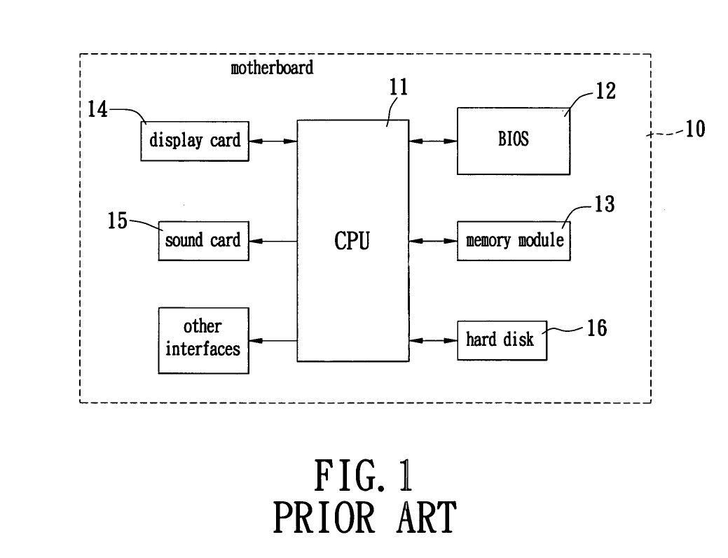

Reference is made to FIG. 1, which is a block diagram of a conventional motherboard. In general, a motherboard 10 is connected with a central processing unit (CPU) 11, a basic input/output system (BIOS) 12, a memory module 13, a display card 14, a sound card 15, at least a hard disk 16, multiple interfaces and so on for constituting a computer.

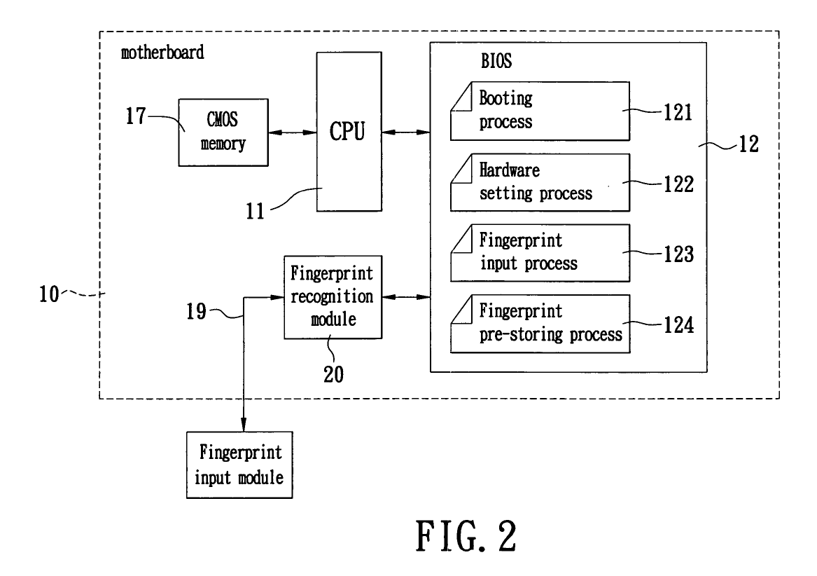

The BIOS 12 has a booting process 121 and a hardware setting process 122 as shown in FIG. 2. The booting process 121 is used to control the basic input/output devices during computer booting, whereas the hardware setting process 122 is used to initially set the basic hardware and store the initial setting values to a complementary metal-oxide semiconductor (CMOS) memory 17.

A conventional method for security of the computer is to employ the hardware setting process 122 to set a password and then store it in the CMOS memory 17. The password can be easily removed via resetting the CMOS memory 17. Hence, this security method is ineffectual.

Reference is made to FIG. 2, which is a block diagram of a motherboard having a fingerprint recognition module in accordance with the present invention. Motherboard 10 of the present invention has a fingerprint recognition module 20, which electrically connects with a fingerprint input module 30 and a BIOS 12. The present invention adds a fingerprint input process 123 to the BIOS 12 and a fingerprint pre-storing process 124 to the BIOS 12. Hence, during computer booting, the BIOS 12 will identify the user by recognizing his fingerprint to provide security.

The fingerprint input module 30 is used to input at least a user's fingerprint image. The fingerprint recognition module 20 is used to recognize the fingerprint signal and convert it into a recognition code. The fingerprint input process 123 is used to control the fingerprint recognition module 20 to compare the recognition code with at least a pre-stored recognition code to produces a comparison result. Then, the BIOS 12 will determine whether or not to boot the computer according to the result.

In general, the BIOS 12 is an electrically erasable programmable read-only memory (EEPROM), which has the booting process and so on as mentioned above. A preferred embodiment of the present invention uses an EEPROM with larger storage capacity as the BIOS 12, which has a storage region to store user's pre-stored recognition code. Hence, when the CMOS memory 17 is reset, the user's pre-stored recognition code in the EEPROM will not be removed so as to provide security.

Of course, the present invention can also use another storage device to store the pre-stored recognition code. The storage device can be a non-volatile memory, such as a flash memory or the hard disk 16. The storage device is electrically connected with the fingerprint recognition module 20 and also used to store temporarily the fingerprint image input from the fingerprint input module 30.

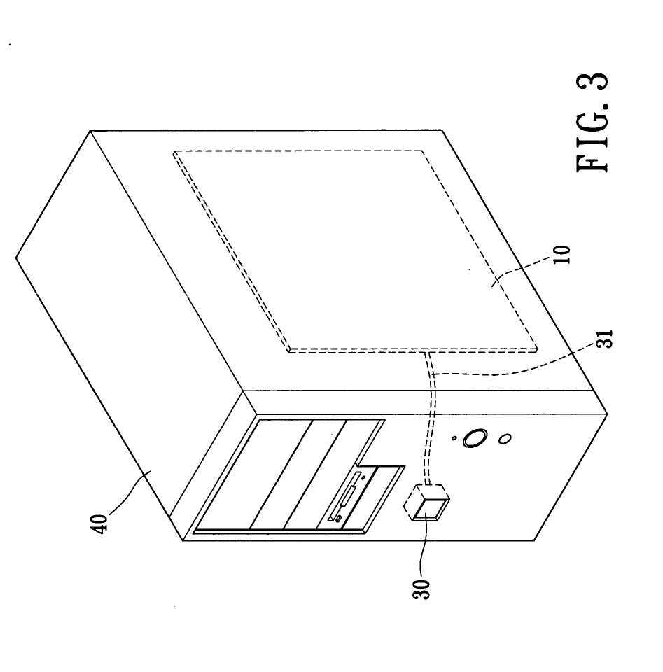

For convenience, the present invention disposes the fingerprint input module 30 on the housing 40 of the computer as shown in FIG. 3, which is a schematic diagram of the first embodiment in accordance with the present invention. The fingerprint input module 30 is electrically connected with the fingerprint recognition module 20 of the motherboard 10 via a fingerprint transmission line 31.

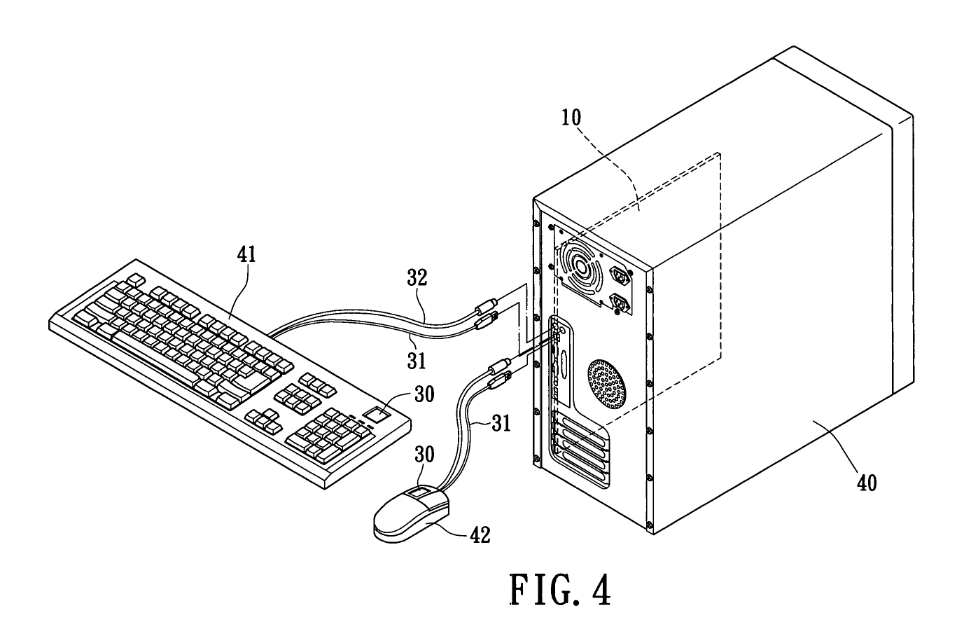

FIG. 4 is a schematic diagram of the second embodiment in accordance with the present invention. The fingerprint input module 30 of the present invention can also be disposed on a keyboard 41 or a mouse 42 and is electrically connected with the fingerprint recognition module 20 via the fingerprint transmission line 31, which is combined with the keyboard transmission line 32 or mouse transmission line 33.

Although the fingerprint recognition module 20 of the present invention is disposed on the motherboard 10, in practice, the fingerprint input module 30 still needs to use a transmission interface as the fingerprint transmission line 31 to electrically connect with the fingerprint recognition module 20. The transmission interface can be a universal serial bus (USB), an IEEE1394 interface, a RS-232 interface, a PS2 interface or a parallel port interface.

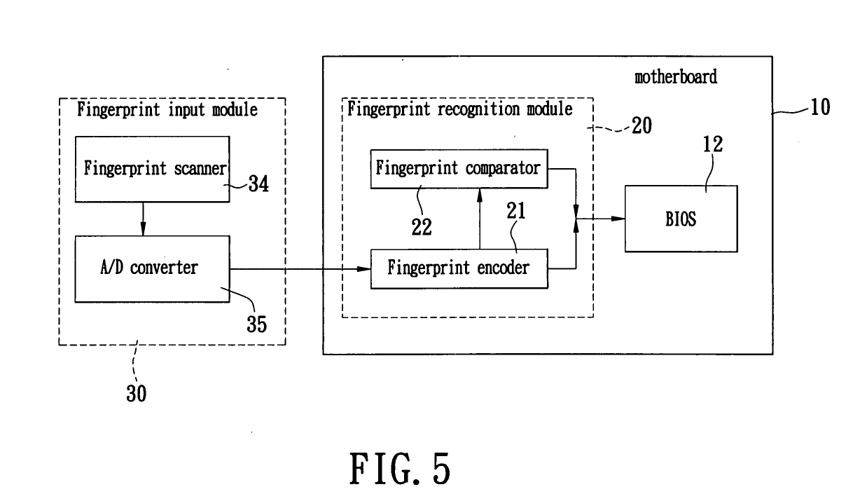

Reference is made to FIG. 5, which is a block diagram of a fingerprint module in accordance with the present invention. The fingerprint input module 30 of the present invention is preferably a fingerprint input integrated circuit (IC) and the fingerprint recognition module 20 can also be a fingerprint recognition IC. The fingerprint input module 30 has a fingerprint scanner 34 (optical type or IC type) and an analog/digital (A/D) converter 35. The fingerprint recognition module 20 has a fingerprint encoder 21 and a fingerprint comparator 22.

The fingerprint scanner 34 is used to input a user's fingerprint image and the A/D converter 35 is used to convert the fingerprint image into a digital fingerprint image signal. The fingerprint encoder 21 is used to abstract the fingerprint features from the digital fingerprint image signal and encode it as a recognition code, whereas the fingerprint comparator 22 is used to compare the recognition code and a pre-stored recognition code to produce a compared recognition.

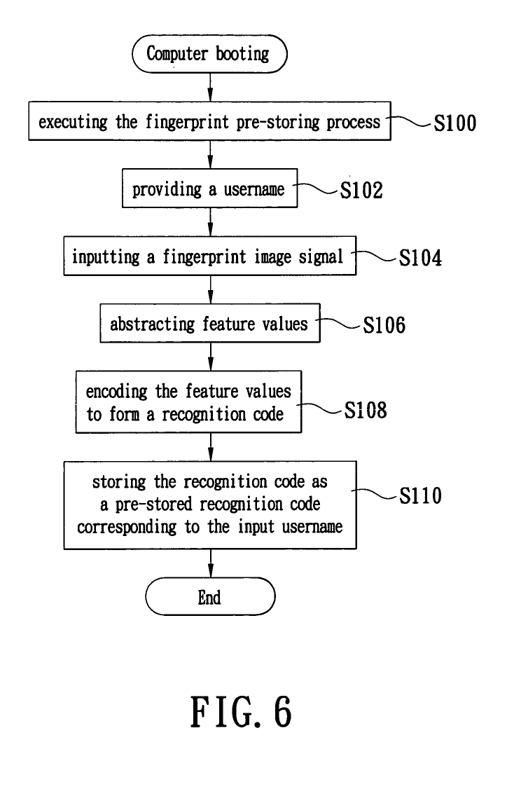

Reference is made to FIG. 6, which is a flowchart of a fingerprint pre-storing process in accordance with the present invention. Since the present invention is used to identify the user before computer booting, it needs to pre-store the user's fingerprint to form the pre-stored recognition code. Hence, executing the fingerprint pre-storing process 124 is necessary during computer booting. A user can choose an item of the menu of the hardware setting process 122 or press a corresponding hot key of the keyboard 41 to execute the fingerprint pre-storing process 124 during computer booting (S100).

First, the user needs to provide a usemame to the fingerprint pre-storing process 124 (S102). Then, the user needs to use the fingerprint input module 30 to produce a fingerprint image signal (S104). The fingerprint image signal will be sent to the fingerprint recognition module 20, which will abstract feature values from the fingerprint image signal (S106), encode the feature values as a recognition code (S108) and then store the recognition code as a pre-stored recognition code corresponded to the input usemame (S110). After finishing the fingerprint pre-storing process, the user can reset the computer.

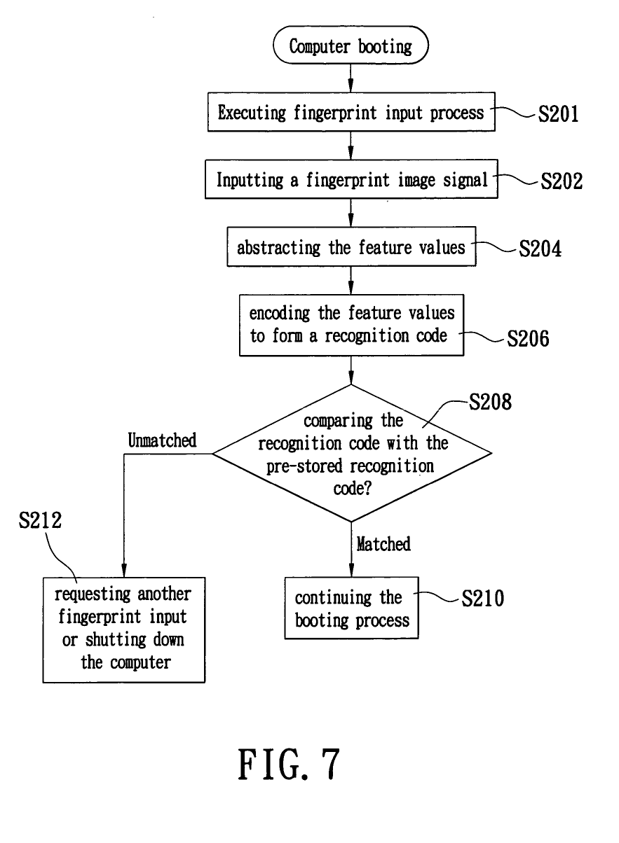

Reference is made to FIG. 7, which is a flowchart of a fingerprint input process in accordance with the present invention. After finishing the fingerprint pre-storing process and re-starting the computer, the computer will execute the booting process 121 and the fingerprint input process 123 (S201). The user can input his fingerprint image via the fingerprint input module 30 to produce the fingerprint image signal (s202). Subsequently, the fingerprint image signal will be sent to the fingerprint recognition module 20 to abstract the feature values (S204) and then encode them to form a recognition code (S206). Finally, the fingerprint recognition module 20 will compare the recognition code with the pre-stored recognition code (S208) to produce a comparison result. If the comparison result shows that the recognition code matches the pre-stored one, the booting process will be continued (S210). Otherwise, the system will require the user to input his fingerprint again or shut down the computer.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for computer booting, which disposes a fingerprint recognition module connected with a fingerprint input module on a motherboard of a computer and executes a fingerprint input process stored in a basic input/output system (BIOS) during booting or resetting the computer, the method comprising:
inputting a fingerprint image signal via the fingerprint input module;
sending the fingerprint image signal to the fingerprint recognition module to produce a recognition code; and
comparing the recognition code with at least a pre-stored recognition code to produce a comparison result, wherein the comparison result is used to determine if booting the computer is permitted.

2. The method as claimed in claim 1, wherein, in the step of inputting the fingerprint image signal, the fingerprint image signal is stored in the BIOS, a non-volatile memory or a hard disk.

3. The method as claimed in claim 1, wherein the step of sending the fingerprint image signal to the fingerprint recognition module to produce the recognition code further comprises:
abstracting at least a feature value from the fingerprint image signal; and
encoding the feature value to form the recognition code.

4. The method as claimed in claim 1, wherein the step of comparing the recognition code with the pre-stored recognition code employs the fingerprint recognition module to compare the recognition code with the pre-stored recognition code

5. The method as claimed in claim 1, wherein the step of comparing the recognition code with the pre-stored recognition code to produce the comparison result used to determine if booting the computer is permitted further comprises:
continuing a booting process if the comparison result shows that the recognition code matches the pre-stored recognition code; and
requesting another fingerprint input or shutting down the computer if the comparison result shows that the recognition code doesn't match the pre-stored recognition code.

6. A method for computer booting, which disposes a fingerprint recognition module connected with a fingerprint input module on a motherboard of a computer and executes a fingerprint pre-storing process stored in a basic input/output system (BIOS) during booting or resetting the computer, the method comprising:
providing a username;
employing the fingerprint input module to provide a fingerprint image signal;
sending the fingerprint image signal to the fingerprint recognition module to produce a recognition code;
storing the recognition code as a pre-stored recognition code corresponding to the usemame; and
resetting the computer.

7. The method as claimed in claim 6, wherein the BIOS is an electrically erasable programmable read-only memory (EEPROM) having a storage region for storing the pre-stored recognition code.

8. The method as claimed in claim 6, wherein the BIOS is a flash memory having a storage region for storing the pre-stored recognition code.

9. The method as claimed in claim 6, wherein, in the step of storing the recognition code, the pre-stored recognition code is stored in a non-volatile memory or a hard disk.

10. The method as claimed in claim 6, wherein, in the step of sending the fingerprint image signal, the fingerprint image signal is stored in the BIOS, a non-volatile memory or a hard disk.

11. The method as claimed in claim 6, wherein the step of sending the fingerprint image signal to the fingerprint recognition module to produce the recognition code further comprises:
abstracting at least a feature value from the fingerprint image signal; and
encoding the feature value to form the recognition code.

12. The method as claimed in claim 6, comprising:
choosing an item of a menu of the BIOS to execute the fingerprint pre-storing process.

13. The method as claimed in claim 6, comprising:
pressing a hot key of a keyboard to execute the fingerprint pre-storing process.

14. A computer motherboard, comprising:
a BIOS having a booting process;
a fingerprint input module used to input at least a first fingerprint image; and
a fingerprint recognition module electrically connected with the fingerprint input module and the BIOS for abstracting a feature value of the first fingerprint image and encoding the feature value to form a recognition code;
wherein, during computer booting, the booting process is able to control the fingerprint recognition module to compare the recognition code with at least a pre-stored recognition code to produce a comparison result used to determine if computer booting is permitted to continue.

15. The computer motherboard as claimed in claim 14, wherein the BIOS is an EEPROM having a storage region for storing the pre-stored recognition code.

16. The computer motherboard as claimed in claim 14, wherein the BIOS is a flash memory having a storage region for storing the pre-stored recognition code.

17. The computer motherboard as claimed in claim 14, wherein the BIOS further has a fingerprint pre-storing process used to input at least a second fingerprint to provide the pre-stored recognition code, and wherein the pre-stored recognition code is stored in a non-volatile memory, via the fingerprint input module and the fingerprint recognition module.

18. The computer motherboard as claimed in claim 14, wherein the fingerprint input module is disposed on a computer housing and connected with the fingerprint recognition module of the computer motherboard via a fingerprint transmission line.

19. The computer motherboard as claimed in claim 14, wherein the fingerprint input module is disposed on a computer keyboard and connected with the fingerprint recognition module of the computer motherboard via a fingerprint transmission line combined with a transmission line of the keyboard.

20. The computer motherboard as claimed in claim 14, wherein the fingerprint input module is disposed on a mouse and connected with the fingerprint recognition module of the computer motherboard via a fingerprint transmission line combined with a transmission line of the mouse.

21. The computer motherboard as claimed in claim 14, wherein the fingerprint input module further comprises:
a fingerprint scanner 34 used to input the first fingerprint image; and
an analog/digital (A/D) converter used to convert the first fingerprint image into a digital fingerprint image signal.

22. The computer motherboard as claimed in claim 14, wherein the fingerprint recognition module is a fingerprint recognition integrated circuit (IC).

23. The computer motherboard as claimed in claim 14, wherein the fingerprint recognition module further comprises:
a fingerprint encoder used to abstract the feature value of the first fingerprint image and encode the feature value to form the recognition code; and
a fingerprint comparator used to compare the recognition code with the pre-stored recognition code to produce the comparison result.

24. The computer motherboard as claimed in claim 14, further comprising:
a storage device electrically connected with the fingerprint recognition module to store the first fingerprint image and the pre-stored recognition code.

25. The computer motherboard as claimed in claim 24, wherein the storage device is a non-volatile memory or a hard disk.

26. The computer motherboard as claimed in claim 25, wherein the non-volatile memory is a flash memory.

27. The computer motherboard as claimed in claim 14, further comprising:
a transmission interface disposed on the computer motherboard to electrically connect the fingerprint recognition module with the fingerprint input module.

28. The computer motherboard as claimed in claim 27, wherein the transmission interface is a universal serial bus (USB), an IEEE1394 interface, a RS-232 interface, a PS2 interface or a parallel port interface.
